(19) United States
(12) Patent Application Publication
(10) Pub. No.: US 2022/0215849 A1
(43) Pub. Date: Jul. 7, 2022

(54) WIRELESS CONNECTION BASE INTEGRATING AN INFERENCE PROCESSING UNIT

(71) Applicant: Plantronics, Inc., Santa Cruz, CA (US)

(72) Inventors: Jonathan Grover, San Jose, CA (US); Scott Walsh, Foxham (GB)

(73) Assignee: Plantronics, Inc., Santa Cruz, CA (US)

(21) Appl. No.: 17/143,035

(22) Filed: Jan. 6, 2021

(51) Int. Cl. G10L 19/16; H04L 9/32; G06F 13/38; G06F 13/42; G06F 3/16

(52) U.S. Cl. CPC G10L 19/167; H04L 9/3247; G06F 3/162; G06F 13/4282; G06F 13/385

(57) ABSTRACT

A connection base includes a first connection interface for connecting to and receiving an audio stream from a first endpoint, and a second connection interface for connecting to and transmitting the audio stream to a second endpoint. The connection base further includes an inference processing unit (IPU), connected to the first connection interface and the second connection interface, the IPU configured to execute an inference algorithm on an audio stream to obtain an inference result. The connection base is configured to output the inference result.

### BACKGROUND

Audio devices are devices that include one or more speakers and microphones. Wireless audio devices may connect to a computer system via a wireless connection. As such, wireless audio devices include a wireless connection, a battery, and a processor. In the wireless audio device, a tradeoff exists between the processing circuitry and the amount of battery usage. In order to conserve the battery power, minimal processing circuitry may be used. Thus, additional processing may be performed by central processing unit of the computing system that is connected to the wireless audio device.

### SUMMARY

In general, in one aspect, one or more embodiments relate to a connection base including a first connection interface for connecting to and receiving an audio stream from a first endpoint, and a second connection interface for connecting to and transmitting the audio stream to a second endpoint. The connection base further includes an inference processing unit (IPU), connected to the first connection interface and the second connection interface, the IPU configured to execute an inference algorithm on an audio stream to obtain an inference result. The connection base is configured to output the inference result.

In general, in one aspect, one or more embodiments relate to a method including receiving, by a connection base from a first endpoint, an audio stream in a first signal type, the audio stream directed to a second endpoint, the connection base being directly connected to the first endpoint and the second endpoint. The method further includes executing an inference algorithm on the audio stream by an inference processing unit (IPU) to obtain an inference result, translating the audio stream from the first signal type to a second signal type to obtain a translated audio stream, and outputting the inference result and transmitting the translated audio stream to the second endpoint.

In general, in one aspect, one or more embodiments relate to a system that includes a headset, and a universal serial bus (USB) dongle. The USB dongle includes a wireless connection interface for connecting to and receiving an audio stream from the headset, a USB interface for connecting to and transmitting the audio stream to a computer system, and an inference processing unit (ISP), connected to the wireless connection interface and the USB interface. The IPU is configured to execute an inference algorithm on an audio stream to obtain an inference result. The USB dongle is configured to output the inference result.

In general, in one aspect, one or more embodiments relate to a system including multiple connection bases. The multiple connection bases include a first connection interface for connecting to and receiving an audio stream from a first endpoint, a second connection interface for connecting to and transmitting the audio stream to a second endpoint, and multiple inference processing units (IPUs) configured to execute an inference algorithm on an audio stream to obtain an inference result. The connection bases each include an IPU of the multiple IPUs. The connection bases are configured to output the inference result.

Other aspects will be apparent from the following description and the appended claims.

### BRIEF DESCRIPTION OF DRAWINGS

FIG. 1A shows a diagram of a system in accordance with one or more embodiments.

FIG. 1B shows a diagram of a system in accordance with one or more embodiments.

FIG. 2 shows an example in accordance with one or more embodiments.

FIG. 3 shows an example connection base in accordance with one or more embodiments.

FIG. 4 shows an example connection base in accordance with one or more embodiments.

FIG. 5 shows a flowchart to configure the connection base in accordance with one or more embodiments.

FIG. 6 shows a flowchart for processing by the connection base in accordance with one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to integrating an inference processing unit (IPU) into a connection base. The IPU may also be referred to as an intelligence processing unit. The connection base is a device that passes through at least an audio stream between a computer system and an endpoint. For example, the connection base may be configured to translate the audio stream between the different signal types of the computer system and audio device. The IPU is a special purpose hardware processor (i.e., an application specific integrated circuit (ASIC), a field programmable gate array (FPGA) and any combination of fixed function and configurable function logic blocks) that is configured to process inference algorithms. The circuitry of the IPU is specifically designed for executing mathematical operations of inference algorithms. Stated another way, the IPU is a computational processor and related interconnect components that has been specialized in a manner to optimize performance when executing/evaluating inference algorithms designed to infer an output, classify an input, or process input (e.g., through a decision tree). By integrating IPU in the connection base, the connection base is able to process inference algorithms while satisfying battery usage requirements.

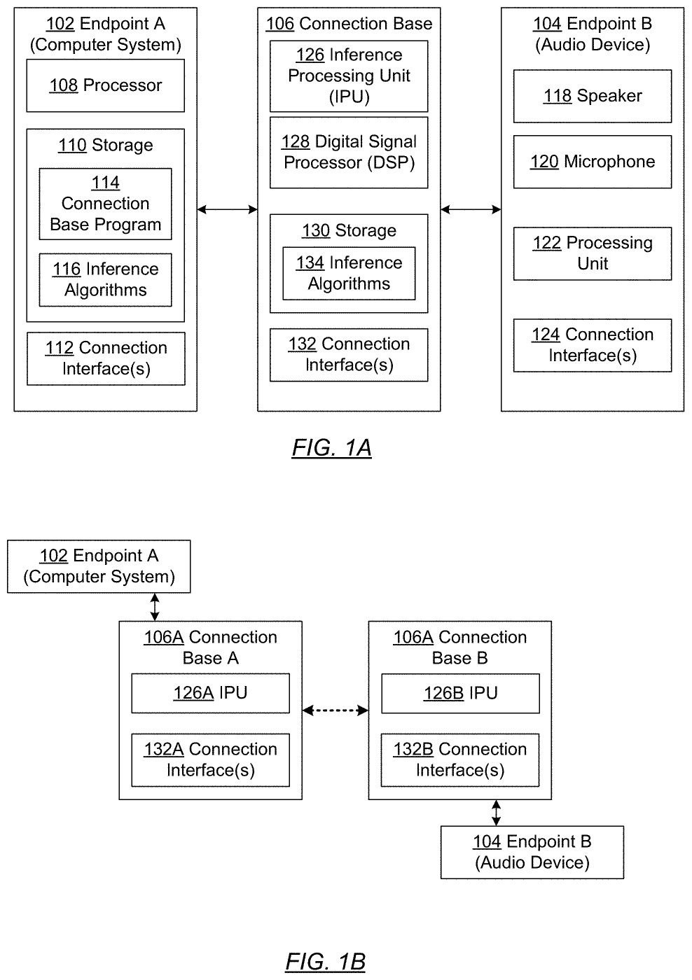

Turning to FIG. 1A, FIG. 1A shows a diagram of a system in accordance with one or more embodiments. As shown in FIG. 1A, the system includes endpoints (e.g., endpoint A (102), endpoint B (104)) with the connection base (106) interposed between the endpoints. The connection base (106) is directly, wired or wirelessly, connected to the respective endpoints. For at least one audio stream, the connection base (106) is interposed between the endpoints (e.g., endpoint A (102), endpoint B (104)).

The endpoints (e.g., endpoint A (102), endpoint B (104)) are the hardware devices directly connected to the connection base (106). At least one endpoint (e.g., endpoint A (102)) is a computer system and at least one endpoint (e.g., endpoint B (104)) is an audio device. A computer system as used herein may be a mobile device (e.g., mobile phone), augmented reality device or glasses, a laptop computer, a desktop computer, tablet, or other such computing device. The computer system (i.e., endpoint A (102)) includes processor (108), storage (110), and connection interface(s) (112). The processor (108) includes one or more hardware processing circuits that executes applications on the computer system. The processor (108) may include one or more processing cores of a central processing unit, graphical processing unit, and other processing circuitry.

The storage (110) may include non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.). The storage (110) may include functionality to store, in whole or in part, temporarily or semi-permanently, a connection base program (114) and one or more inference algorithms (116).

The connection base program (114) is a program that, when executed by processor (108), provides a software interface to the connection base (106). The connection base program (114) includes functionality to configure to the connection base (106), such as on the request of a user. For example, the connection base program (114) may include functionality to configure the connection base (106) with an inference algorithm. Configuring the connection base (106) may including loading the inference algorithm on the connection base (106) and configuring the inference algorithm operations on the connection base (106). The connection base program (114) may be configured to obtain, from a network, the inference algorithms (116) and load one or more of the inference algorithms (116) onto the connection base (106).

Inference algorithms (116) are artificial intelligence algorithms in which computer systems learn connections between input and output based on training data. The training data includes training input and the expected output. Using the training data, the inference algorithms self-modify through iterative adjustments to produce correct output based on a set of input. The output of the inference algorithm is an inference result. The inference algorithm may be a machine learning algorithm, such as a neural network, a decision tree, random forest, Bayesian algorithm, or other type of machine learning model.

In some embodiments, the training of the inference algorithm is performed by a different entity than the connection base. For example, a remote computer (not shown), the computer system in conjunction with the remote computer, or the computer system may train the inference algorithm. The connection base may then only execute the pre-trained inference algorithm (e.g., by performing the inference operations of the pre-trained inference algorithm on new input).

The system may provide various functionalities through the inference algorithms. For example, the inference algorithms (116) may include a sentiment determination algorithm, a coaching algorithm, a transcription algorithm, a translation algorithm, an audio quality improvement algorithm, or other types of algorithms.

A sentiment determination algorithm determines the sentiment of a speaker on a call. The speaker may be a remote speaker or a user of the audio device. For example, a sentiment determination algorithm may use features, such as tone, inflection, words, and other features, to estimate a speaker's feeling. Thus, the sentiment determination algorithm may reflect the sentiment of the speaker regarding a topic being discussed. The inference result of the sentiment determination algorithm is a description or identifier of a user's feelings. The description or identifier may be added as metadata to the audio stream.

A coaching algorithm is an algorithm that coaches a user to achieve a goal.

For example, the coaching algorithm may coach a user through performing an interview, public speaking, debating, making a request, or performing another speaking action. Similar to the sentiment determination, the coaching algorithm may use features, such as tone, inflection, words, sentences, phrases, and other features to predict the outcome of the user's speech and suggest modifications. The inference result of the sentiment determination algorithm may include a description or identifier of a suggested modification and/or a score of the user.

A transcription algorithm is an algorithm that transcribes audio into text. The transcription algorithm may or may not be trained for a particular speaker. The transcription algorithm may be an estimation that accounts for speech patterns of different speakers, accent, whether the speaker is sick, etc. Further, the transcription algorithm may be configured to transcribe speech from multiple speakers. For example, the transcription algorithm may detect the speaker speaking and add an identifier of the speaker to the transcription. The inference result of a transcription algorithm is a transcription. For example, the transcription may be added as metadata to enhance the audio stream before the audio stream is transmitted to the computer system and then onto a remote destination.

A translation algorithm is an algorithm that translates audio input from a first natural language to a second natural language. The inference result of the translation algorithm may be audio and/or text. For example, the translation algorithm may be configured to translate incoming speech into a language that a user may understand (e.g., the native language of a user).

The audio quality improvement algorithm is an algorithm configured to block outside noise. For example, the audio quality improvement algorithm may be configured to clean the audio of a remote speaker or the user. By way of example, the audio quality improvement algorithm may remove unwanted background noise, such as a baby crying, dog barking or airplane engine. The inference result of the noise block audio may be modified audio.

The above are only a few examples of the inference algorithms that may be used. Other inference algorithms may be used without departing from the scope of the claims. In addition to audio, the inference algorithm may use as input other signals, such as biometrics and physical motion. For example, if the audio device had a perspiration sensor, then the sentiment determination algorithm could process the near end user's perspiration (with or without audio data) to determine sentiment. Similarly, if the audio device had a motion sensor, the inference algorithm may use the user's motion to perform the inference operations. Further, the inference algorithms may be stored in a market accessible via a network to the computer system (i.e., endpoint A (102)).

Continuing with FIG. 1A, the computer system (i.e., endpoint A (102)) includes connection interface(s). The connection interfaces are physical circuitry for establishing direct connection and for establishing a network connection. For example, the direct connection interface may be Bluetooth interface, universal serial bus (USB) interface, or other point to point connection interface. The network interface is an interface for establishing a network connection with a remote device. For example, the network interface may be a network interface card to connect to a network (not shown) (e.g., a local area network (LAN), a wide area network (WAN) such as the Internet, mobile network, or any other type of network).

Although not shown in FIG. 1A, the computer system may include one or more output devices, such as a display device, and an input device (e.g., touchscreen, keyboard, mouse, or other input).

The audio device (i.e., endpoint B (104)) is a device that is configured to receive and play audio for a user. In one or more embodiments, the audio device is a wireless audio device that may operate on battery power. For example, the audio device may be a headset (over the head headset, earbuds, or other type of headset that is worn on the user's head), a speaker phone or another type of audio device. As shown in FIG. 1A, the audio device (i.e., endpoint B (104)) includes one or more speakers (118) that is configured to play audio signals, one or more microphones (120) configured to detect audio signals, a processing unit (122), and one or more connection interface(s). The processing unit (122) may be a digital signal processor (DSP). For example, the processing unit (122) may be configured to filter, encode, and/or decode audio.

The connection interfaces (124) are communication interfaces for establishing a direct connection with another physical device (e.g., endpoint A (102)), connection base (106). For example, the connection interfaces (124) may include a USB interface, Bluetooth interface, or another interface. For a wireless audio device, the connection interfaces (124) include a wireless interface.

The connection base (106) is interposed between the endpoints and is directly connected to the endpoints. For example, the connection base (106) may be a USB dongle for establishing a USB connection with the computer system and a Bluetooth connection with the audio device. As another example, the connection base may be a charging case, such as a headset storage case, or another such device. By way of another example, the connection base may be a speaker phone that connects to a headset and computer system. The connection base (106) includes an IPU (126), a DSP (128), storage (130), and connection interface(s) (132). The storage (130) is hardware that includes functionality to store one or more inference algorithm(s) (134) for execution by the IPU (126). The inference algorithm(s) (134) may be pretrained prior to being loaded on the connection base (106). The connection interface(s) (132) on the connection base (106) are interfaces for establish direct connections with the computer system and the audio device, respectively.

Although FIG. 1A shows a single connection base, multiple connection bases may be connected in a daisy chain. FIG. 1B shows the connection base connected in a daisy chain. In FIG. 1B, components 106A and 106B, 126A and 126B, and 132A and 132B are substantially the same as components 106, 126, and 132, respectively, shown in FIG. 1A. Further, endpoint A (102) and endpoint B (104) in FIG. 1A are the same as endpoint A (102) and endpoint B (104), respectively, in FIG. 1B.

In the daisy chain, endpoint A (102) is directly connected to connection base A (106A), connection base A (106A) is connected (e.g., directly or via one or more connection bases) to connection base B (106B), and connection base B (106B) is connected to endpoint B (104). Each connection base has one or more IPUs (e.g., 126A, 126B) and connection interfaces (e.g., 132A, 132B). The two or more IPUs may do a sequence of calculations (e.g., for the same or different inference algorithm), the same calculation (i.e., for the same inference algorithm), or in parallel for the same or different inference algorithm. If the same inference algorithm, the inference operations of the inference algorithm may be partitioned into parts, whereby different connection bases perform the different parts to produce intermediate results. One or more of the connection bases may each combine two or more of the intermediate results. The final result is a result of the combination of the intermediate results.

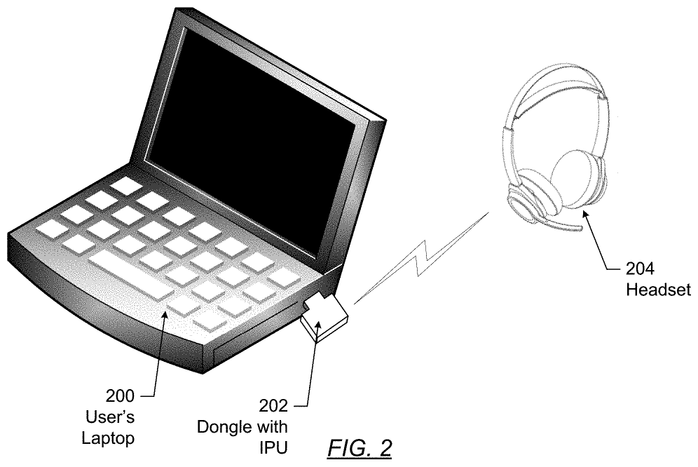

FIG. 2 shows an example in accordance with one or more embodiments. In particular, FIG. 2 shows an example of how one or more embodiments may be implemented. As shown in FIG. 2, a user's laptop (200) is connected to a USB dongle (202) having an IPU via a USB connection. The USB dongle (202) is connected via a Bluetooth connection to a headset (204). Through the user's laptop (200), one or more inference algorithms may be loaded onto the USB dongle (202). Further, via the user's laptop (200), a remote audio stream received from a network (not shown) may be transmitted to the USB dongle (202). The USB dongle (202) is configured to process the audio stream using the IPU to generate an inference result. The USB dongle is further configured to transmit the remote audio stream to the headset (204). A local audio stream from a microphone of the headset (204) may be transmitted directly to the USB dongle (202). The USB dongle (202) may process the local audio stream via the IPU to obtain an inference result and pass the local audio stream to the user's laptop (200) for transmission on the network to a remote endpoint (i.e., an endpoint that is connected remotely via the network). The USB dongle (202) may further be configured to transmit one or more of the inference results to the user's laptop (200) and/or the headset (204). By having the connection base be a USB dongle, the connected computer system becomes the source of power. Thus, the IPU may not need to be optimized as a low power solution.

FIG. 3 shows an example connection base in accordance with one or more embodiments. Specifically, FIG. 3 shows an example functional diagram of the circuitry coupling between components of the connection base (300). The coupling corresponds to linkages between the various circuitry elements. The storage (not shown) may be a centralized or distributed storage. As shown in FIG. 3, the connection base (300) includes radio circuitry (302) configured to transmit radio signals to the wireless audio device. By way of an example, the radio signals may be Bluetooth signals. The radio circuitry (302) may be coupled to the DSP (304). The DSP (304) may provide filtering, compression, and other processing of the audio signal. The DSP (304) may be coupled with the IPU (306) and the PCM audio circuitry (308). The IPU (306) may also be coupled to the PCM audio circuitry (308). The PCM audio circuitry (308) may be connected to USB connection (310). The USB connection (310) is the USB hardware interface of the connection base (300).

In the configuration of FIG. 3, the IPU (306) may execute asynchronously and in parallel with the processing of the audio signals by the remainder of the connection base (300). Further, in some embodiments, the IPU (306) may be in the path of processing the audio signals before the signals are transmitted to the endpoint. By keeping the IPU (306) in serial as part of the processing path, the inference results may be a part of the audio signal transmitted to the endpoint. For example, the audio signal and the inference result that is transmitted may be an altered voice in the case that the inference algorithm is a voice modification algorithm. As another example, the audio signal and the inference result may be transmitted as a single translation of the original audio stream (e.g., in a different language) with or without transmitting the audio signal in the original language.

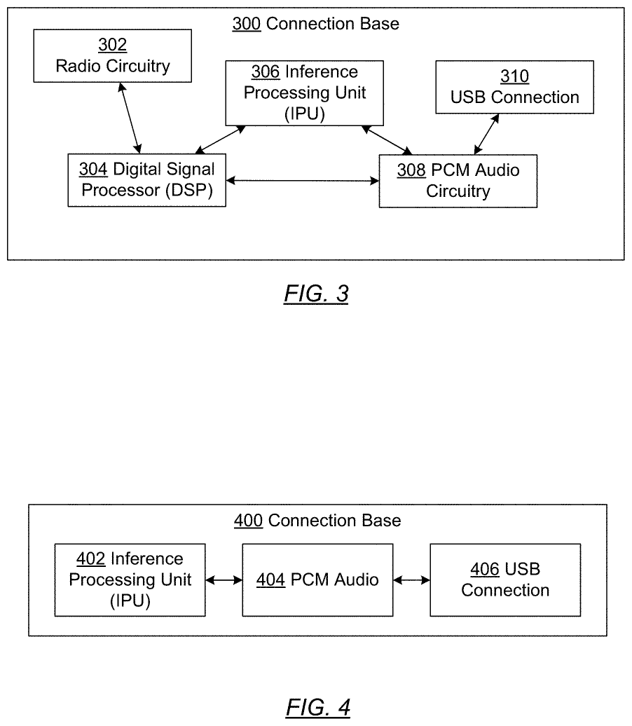

In some embodiments, the connection base may provide offload capability for the computer system. The offload capability may be in addition to processing pass through audio between endpoints or may be instead of processing pass through audio. For example, in addition to processing pass through audio with inference algorithms, the inference algorithm executing on the IPU on the connection base may process data streams from the computer system to produce inference results that are passed back to the computer system. The data stream may be dropped. As another example, the offload capability may be instead of pass through functionality, such as using the embodiment shown in FIG. 4. For example, a USB dongle with an integrated IPU may include firmware that allows the USB dongle to intelligently handle workloads from the connected headset(s)/peripherals. Additionally, the USB dongle may be deployed with personal computer (PC) software or operating system level device drivers that enable the connected PC to leverage the USB dongle as an additional IPU compute unit.

FIG. 4 shows another example connection base (400) in accordance with one or more embodiments. In the example of FIG. 4, the connection base (400) includes an IPU (402) coupled with PCM audio circuitry (404). The PCM audio circuitry (404) is coupled to the USB connection (406). In the configuration of FIG. 4, the connection base (400) is a USB dongle that provides the IPU functionality.

FIG. 3 and FIG. 4 are for example purposes only. Various different configurations and connections may be used without departing from the scope of the claims. For example, the multiple possible arrangements between IPU (306), PCM audio circuitry (308), and USB connection (310) in FIG. 3 may be used. For example, the IPU (306) may be directly connected to the USB connection (310). By way of another example, the PCM audio circuitry may be omitted.

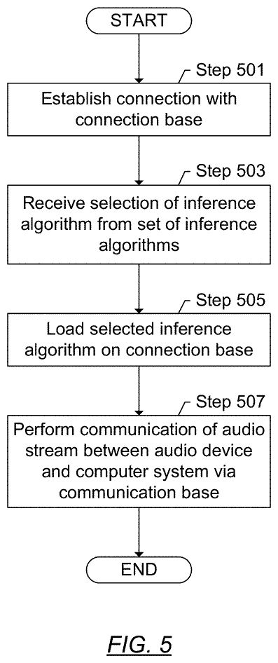

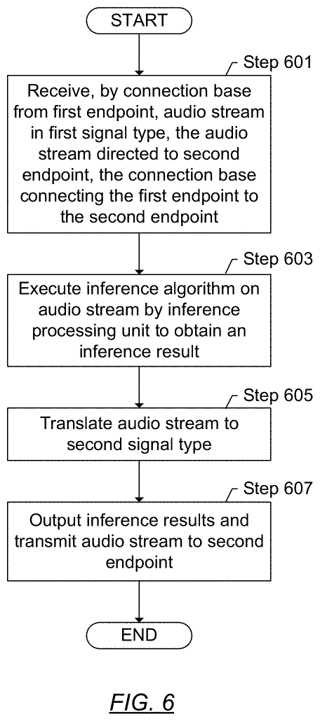

FIG. 5 shows a flowchart to configure the connection base in accordance with one or more embodiments. FIG. 5 is optional as the connection base may be preconfigured with inference algorithms and the user may not want to reconfigure the connection base. In such a scenario, after connecting the connection base to the computer system, processing may proceed to FIG. 6.

Continuing with FIG. 5, in Step 501, a connection with the connection base is established. The connection base is connected electronically with the computer system. For example, the USB interface on the connection base may be connected to the computer system via a USB port on the computer system. In response to the connection, the USB bus driver on the computer system may send a USB request to the connection base to identify the connection base. In response to the identification of the connection base, the driver of the connection base is loaded, and the execution of the connection base program is initiated. The connection base program may display an interface to a user.

In Step 503, a selection of an inference algorithm is received from a set of inference algorithms. A set of inference algorithms are presented to the user. For example, the set of inference algorithms may be presented via a web browser or via the connection base program. Each of the set of inference algorithms may be presented with an identifier and/or description of the inference algorithm. The user interface may receive a selection of an inference algorithm.

In Step 505, the selected inference algorithm is loaded on the connection base. Specifically, the selected inference algorithm may be transferred via the connection interface to storage on the connection base. Further, the interface algorithm may be configured on the connection base. The configuration may be dependent on the type of inference algorithm. For example, a voice modification algorithm may be configured with the type of modification. Once configured, the IPU may process the audio streams using the selected inference algorithm.

In Step 507, communication of the audio stream between the computer system and the audio device via the connection base is performed. In one or more embodiments, the connection base acts as a pass-through device for the audio stream. Further, the IPU of the connection base processes the audio stream. The connection via the connection base may be a one-way connection from a first endpoint to a second endpoint or a bidirectional connection between the two endpoints. In the example, the first endpoint may be the computer system and the second endpoint may be the audio device or the first endpoint may be the audio device and the second endpoint may be the computer system. By having a dedicated IPU, the connection base provides additional functionality to the audio device and the computer system. Namely, the general processor of the computer system, which has less efficiencies, does not need to process the inference algorithm. Further, the connection base provides inference algorithm functionality to the audio device, which may not otherwise be capable performing because of only having a DSP.

FIG. 6 shows a flowchart for processing by the connection base in accordance with one or more embodiments. In Step 601, the connection base receives from a first endpoint an audio stream in a first signal type, whereby the audio stream is directed to a second endpoint and the connection base connects the first endpoint to the second endpoint. The connection base receives the audio stream via a first signal type. The audio stream may be transmitted individually, or the audio stream may be transmitted with the video stream. The signal type of the audio stream is dependent on the connection interface of the audio stream. For example, an incoming audio stream from a computer system may be transmitted via USB audio data as packets. The incoming audio stream from a wireless audio device may be received as radio signals.

In Step 603, the inference algorithm is executed on the audio stream by the IPU to obtain an inference result. Further, in Step 605, the audio stream is translated into a second signal type. The processing of Step 603 and Step 605 may be performed in various orders depending on the inference algorithm and connection base configuration. Further, Step 605 may encompass multiple steps. For example, incoming audio stream may be translated into an intermediate signal type (e.g., PCM audio) and passed to the inference algorithm for processing. The inference algorithm executes on the IPU to produce an inference result. Because of the incorporation of the IPU on the connection base, the execution of the inference algorithm may be faster and more efficient. The inference result may be incorporated with the audio stream and/or video stream or maintained separately. Concurrently with the processing by the inference algorithm or after being processed by the inference algorithm, the audio stream is translated to the second signal type. For example, the audio stream may be translated from the intermediate signal type to the second signal type for direct transmission to the second endpoint. As with the first signal type, the second signal type and is dependent on the communication interface that connects the connection base to the second endpoint.

In Step 607, inference results are outputted, and the audio stream is transmitted to a second endpoint. The inference result may be outputted to the same or different endpoint as transmitted the audio stream. Further, outputting the inference result may be performed by incorporating the inference result in the audio stream and then transmitting the inference result with the audio stream. As another technique, the outputting of the inference result may be separate from the audio stream. For example, the inference result may be transmitted to one endpoint and the audio stream transmitted to a second endpoint. Whether the inference result is outputted together or separately with the audio stream may be dependent on the type of inference algorithm. For example, if the inference algorithm is a voice modification algorithm or a translation algorithm, the inference result may be incorporated in the audio stream by replacing the original audio stream. If the inference algorithm is a transcription algorithm or sentiment algorithm, the inference result may be transmitted separately to the computer system for display (e.g., as video data injected in a video stream, as text that a user interface on the computer system displays).

As shown, one or more embodiments improve the operations of the overall system by incorporating inference algorithms into a connection base. Inference algorithms often perform significantly better and in a more power efficient manner on specialized hardware in the form of inference processing units. For older laptop or desktop hardware, which is either “underpowered” (i.e. unable to handle inference operations at the rate required), or “overutilized” (i.e. capable of handling inference operation, inference algorithms executing on the computer system itself may put strain on the system and impacting the user's experience. Thus, despite the availability of inference algorithm solutions, computer systems may be unable to take advantage of the solutions.

One or more embodiments are able to handle hybrid processing of inference-based operations from the headset. Hybrid processing means that part of the processing operation is handled on the headset and part of the processing offloaded to the connection base. Below are some examples of hybrid processing.

A first example involves using a wake word on the audio device. In this example, the audio device with limited processing capacity, aims to detect a wake word/hot word. Due to limited processing capacity and battery constraints, the audio device makes a rapid (but potentially incorrect determination) as to whether a wake word is detected. If the audio device detected a wake word, the data is sent over the wireless link to the connection base that can run a more robust/power intensive validation and do so rapidly. The connection base responds back to the audio device over the wireless link as to whether or not a wake word was actually spoken.

A second example is with respect to intent processing. In this example, after detecting a wake word, the user has spoken an intent, such as “Hey, turn up the volume.” The connection base is given the voice data related to the intent and performs operations to convert speech to text and process the intent. The inference result from the IPU on the connection base is then transmitted so that the intent acted upon (by either the audio device or the companion PC). In this example, the connection base can also act to orchestrate the action after the intent is determined (e.g., determine whether the action/command needs to be sent to the audio device or to the computer system).

One or more embodiments may be used to offload processing. For example, the processing offload may be to perform real-time translation. In this example, the user has requested real-time translation of the audio being heard from the original language to one that the user understands. In one instance, the audio from the original source is processed by the connection base before being passed to the wireless link to transmit to the audio device. In another instance, the audio device having received audio stream for translation passes the audio back to the connection base, where audio stream is translated and then sent back to the audio device.

By adding the IPU to the connection base, the connection base may be a soft upgrade for the audio device. Namely, rather than a buyer purchasing a new audio device, the buyer may purchase the connection base to obtain the additional functionality of inference algorithms.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A connection base comprising:
a first connection interface for connecting to and receiving an audio stream from a first endpoint;
a second connection interface for connecting to and transmitting the audio stream to a second endpoint; and
an inference processing unit (IPU), connected to the first connection interface and the second connection interface, the IPU configured to execute an inference algorithm on an audio stream to obtain an inference result,
wherein the connection base is configured to output the inference result.

2. The connection base of claim 1, further comprising:
a digital signal processor (DSP) configured to translate the audio stream from a first signal type to a second signal type prior to transmitting the audio stream to the second endpoint.

3. The connection base of claim 1, further comprising:
a pulse code modulation (PCM) audio circuitry coupled to the first connection interface and to the ISP; and
a digital signal processor (DSP) coupled to the IPU, the PCM audio circuitry, and the second connection interface, the DSP configured to translate the audio stream from a first signal type to a second signal type prior to transmitting the audio stream to the second endpoint.

4. The connection base of claim 1, wherein the second connection interface is configured to output the inference result with the translated audio stream.

5. The connection base of claim 1, wherein the connection base is configured to transmit the inference result to the first endpoint via the first connection interface.

6. The connection base of claim 1, wherein the first connection interface is a universal serial bus (USB) interface, and wherein the second connection interface is a Bluetooth connection interface.

7. The connection base of claim 1, wherein the connection base is a dongle.

8. The connection base of claim 1, wherein the connection base is a headset storage device.

9. A method comprising:
receiving, by a connection base from a first endpoint, an audio stream in a first signal type, the audio stream directed to a second endpoint, the connection base being directly connected to the first endpoint and the second endpoint;
executing an inference algorithm on the audio stream by an inference processing unit (IPU) to obtain an inference result;
translating the audio stream from the first signal type to a second signal type to obtain a translated audio stream; and
outputting the inference result and transmitting the translated audio stream to the second endpoint.

10. The method of claim 9, further comprising:
outputting the inference result with the translated audio stream.

11. The method of claim 9, further comprising:
injecting the inference result in a video stream.

12. The method of claim 9, further comprising:
transmitting the inference result to the first endpoint.

13. The method of claim 9, wherein the first endpoint is an audio device and the second endpoint is a computer system.

14. The method of claim 9, wherein the first endpoint is a computer system and the second endpoint is an audio device.

15. The method of claim 9, further comprising:
receiving a selection of the inference algorithm from a set of inference algorithms; and
loading, based on the selection, the inference algorithm onto the connection base.

16. The method of claim 9, wherein the audio stream is translated by a digital signal processor located on the connection base.

17. The method of claim 9, wherein the connection base is a universal serial bus (USB) dongle.

18. The method of claim 9, wherein the connection base is a headset storage device.

19. A system comprising:
a headset; and
a universal serial bus (USB) dongle, the USB dongle comprising:
a wireless connection interface for connecting to and receiving an audio stream from the headset,
a USB interface for connecting to and transmitting the audio stream to a computer system, and
an inference processing unit (ISP), connected to the wireless connection interface and the USB interface, the IPU configured to execute an inference algorithm on an audio stream to obtain an inference result,
wherein the USB dongle is configured to output the inference result.

20. A system comprising:
a plurality of connection bases comprising:
a first connection interface for connecting to and receiving an audio stream from a first endpoint,
a second connection interface for connecting to and transmitting the audio stream to a second endpoint, and
a plurality of inference processing units (IPUs) configured to execute an inference algorithm on an audio stream to obtain an inference result,
wherein the plurality of connection bases each comprise an IPU of the plurality of IPUs, and
wherein the plurality of connection bases are configured to output the inference result.

21. The system of claim 20, wherein the plurality of connection bases are arranged in a daisy chain whereby an initial connection base in the daisy chain comprises the first connection interface and a last connection base in the daisy chain comprises the second connection interface.
